(19) United States
(12) Patent Application Publication
(10) Pub. No.: US 2011/0181195 A1
(43) Pub. Date: Jul. 28, 2011

(54) DECORATIVE LIGHTING DEVICE

(75) Inventor: Jing Nan Chen, Taipei City (TW)

(73) Assignee: FORECHEN INC., Taipei City (TW)

(21) Appl. No.: 13/013,647

(22) Filed: Jan. 25, 2011

(30) Foreign Application Priority Data
Jan. 27, 2010 (TW) 099201677
May 25, 2010 (TW) 099209857

(51) Int. Cl. H05B 37/00

(52) U.S. Cl. 315/192

(57) ABSTRACT

A decorative lighting device includes at least one movable decorative element and a plurality of string light sets. A power supply drives each string light set to form a current loop respectively. Each string light set respectively has a plurality of lamp holders connected to each other in series. The lamp holder is respectively selectively electrically connected to a light-emitting element or the movable decorative element, so that the lamp holder respectively supplies a power to the light-emitting element or the movable decorative element.

### CROSS-REFERENCE TO RELATED APPLICATIONS

This non-provisional application claims priority under 35 U.S.C. §119(a) on Patent Application No(s). 099209857 filed in Taiwan, R.O.C. on May 25, 2010 and Patent Application No. 099201677 filed in Taiwan, R.O.C. on Jan. 27, 2010, the entire contents of which are hereby incorporated by reference.

### BACKGROUND OF THE INVENTION

1. Field of the Invention

The present invention relates to a decorative lighting device, and more particularly to a light-emitting element capable of being disposed or a movable decorative element.

2. Related Art

Decorative string lights are extremely frequently used in various celebrations and evening parties, which can make the blank and gloomy night sky look brilliant and gorgeous. Especially during Christmas, trees on the street are all covered with a great amount of Christmas string lights to welcome the coming of the Christmas festival.

In current Christmas string lights, many Light Emitting Diodes (LEDs) or bulbs connected in series are always used for lighting, and one end is electrically connected to a common commercial power through a power plug. Flashing and brightness of the LEDs or the bulbs can be controlled by a microcontroller through a program.

However, the voltage of the power supplied to the bulbs of the Christmas string lights has to be stepped down by a transformer before the power can be supplied to the LEDs or the bulbs. In order to prevent the LEDs or the bulbs from being burnt due to an excessively high voltage, normally the transformer converts the commercial power into a Direct Current (DC) after stepping down the voltage of the commercial power, so as to supply the DC to the LEDs or the bulbs of the Christmas string lights. However, since the voltage is low, the number of the bulbs that can be disposed to the Christmas string lights is limited, and the limitation also limits the length of the Christmas string lights. When Christmas string lights are required to be wound for a long distance, multiple sets of the Christmas string lights have to be respectively connected to multiple independent power supplies, so as to wind the Christmas string lights for a long distance. However consequently, not only inconvenience is incurred, but also a user has to buy extra power supply equipment, thereby wasting money.

In addition, in order to achieve a more striking effect in using, some rotary objects, such as rotary dolls, may be added. However, in the prior art, the rotary object is required to be equipped with a motor. The motor can only be started by a very large current. The motor cannot be designed together with existing string lights in a circuit. Therefore, the user also has to buy extra power supply equipment before using the rotary objects.

### SUMMARY OF THE INVENTION

Accordingly, the present invention is a decorative lighting device. The decorative lighting device is electrically connected to a power supply. The power supply has a first electrode and a second electrode. The decorative lighting device comprises at least one movable decorative element and a plurality of string light sets.

Each string light set respectively has a plurality of lamp holders connected to each other in series. The lamp holder is respectively electrically connected to a light-emitting element. Each string light set respectively has a first node and a second node, each first node is electrically connected to the first electrode, and each second node is electrically connected to the second electrode. The power supply drives each string light set to form a current loop respectively. All of the light-emitting elements electrically connected to the lamp holders in each current loop can selectively be replaced with the movable decorative elements, so that the lamp holders respectively provide a power for the light-emitting elements or the movable decorative elements.

In an embodiment of the present invention, each string light set respectively has a plurality of lamp holders connected in series and an automatic voltage regulating constant current device. The lamp holder is respectively electrically connected to the light-emitting element. The light-emitting element of each string light set has a different breakover voltage. The automatic voltage regulating constant current device outputs a constant voltage to each string light set.

In another embodiment of the present invention, the movable decorative element has a DC/DC converter. The DC/DC converter has a wide input voltage range, and outputs a power of a steady voltage.

Only a very small current is required to drive the movable decorative element, such that each light-emitting element originally in the decorative lighting device can be selectively replaced with the movable decorative element. Therefore, without being added with extra power supply equipment, the decorative lighting device can be equipped with the movable decorative elements, so as to add more fun to the decorative lighting device.

### BRIEF DESCRIPTION OF THE DRAWINGS

The present invention will become more fully understood from the detailed description given herein below for illustration only, and thus are not limitative of the present invention, and wherein:

FIG. 1A is a schematic view of circuit connection of a decorative lighting device according to the present invention;

FIG. 1B is an equivalent circuit diagram of a decorative lighting device according to the present invention;

FIG. 2A and FIG. 2B are schematic views of a movable decorative element according to the present invention;

FIG. 2C is a circuit diagram of a drive circuit;

FIG. 3A and FIG. 3B are schematic views of connection of a current regulating element according to the present invention;

FIG. 4 shows a movable decorative element having light-emitting elements; and

FIG. 5 shows a movable decorative element having a DC/DC converter.

### DETAILED DESCRIPTION OF THE INVENTION

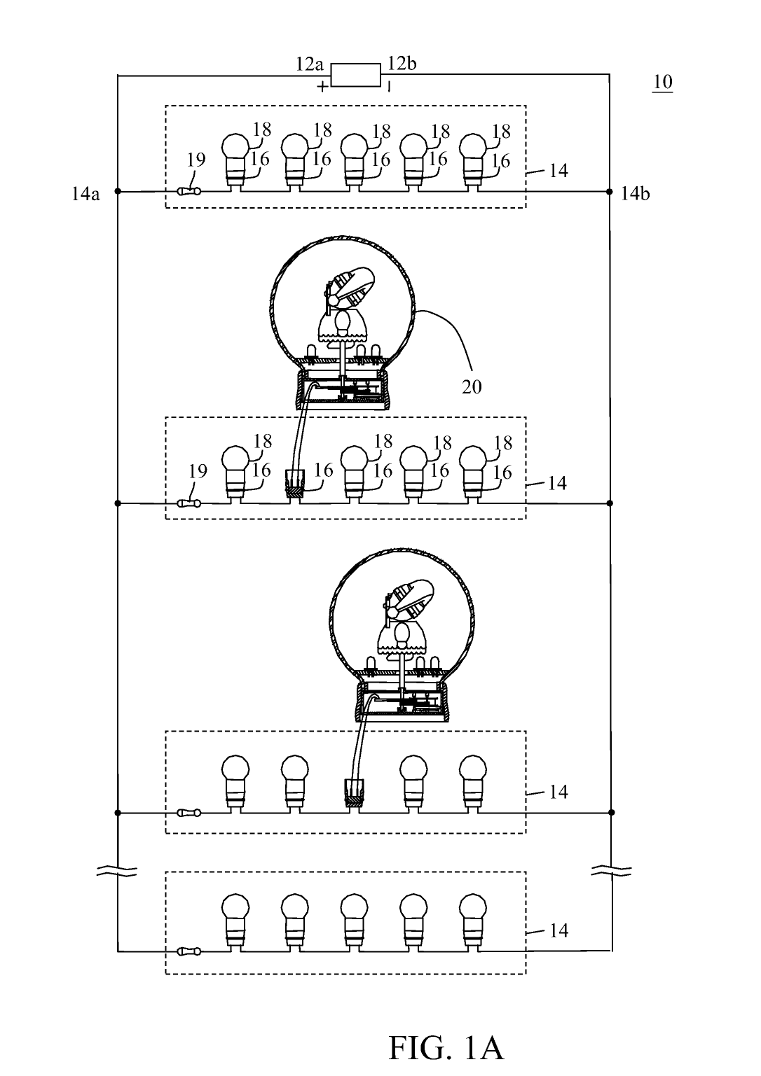

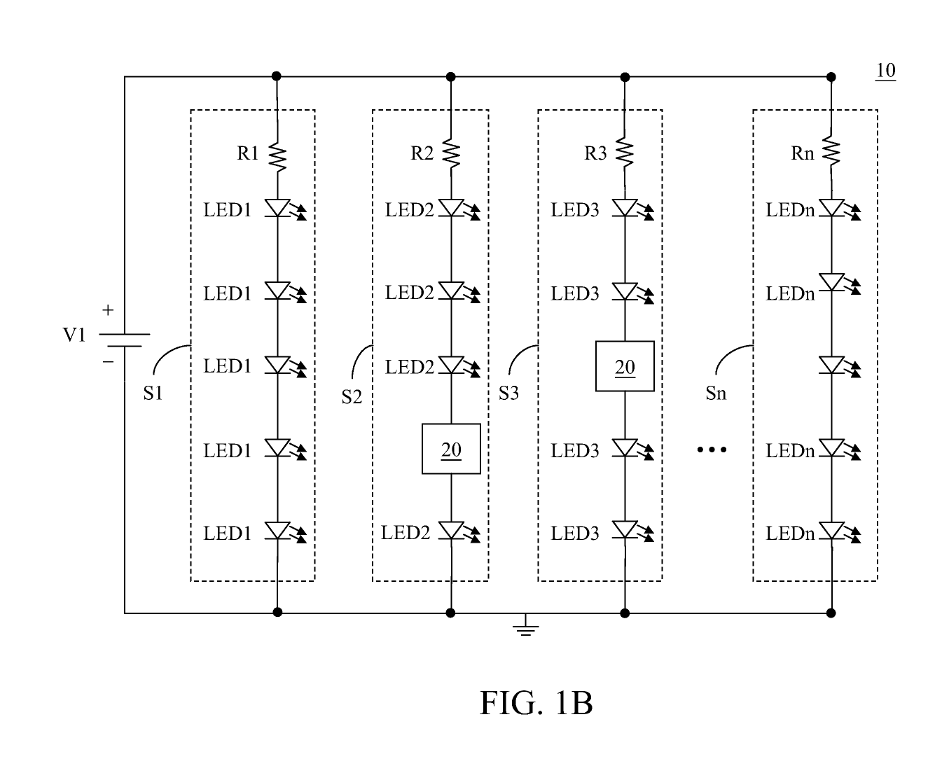

FIG. 1A is a schematic view of circuit connection of a decorative lighting device according to the present invention. Referring to FIG. 1, the decorative lighting device of the present invention is electrically connected to a power supply 12. The power supply 12 has a first electrode 12a and a second electrode 12b. The first electrode 12a and the second electrode 12b are respectively electrically connected to a decorative lighting device 10, thereby supplying a DC to the decorative lighting device 10. In this embodiment, a device for supplying the power supply substantially has a transformer and a rectifier (not shown). A primary side of the transformer may be connected to an Alternating Current (AC), and a secondary side of the transformer is connected to the rectifier, so that the AC is converted into a DC by the rectifier. However, the device for supplying the power supply 12 is only for illustrating a preferred embodiment, the present invention is not limited thereto, and the power source 12 thereof may be a battery or other power supply equipment.

The decorative lighting device 10 includes a plurality of string light sets 14 and at least one movable decorative element 20. In each string light set 14, a plurality of lamp holders 16 is connected to each other in series by a wire, and each lamp holder 16 is electrically connected to a light-emitting element 18. It should be noted that, each string light set 14 has a first node 14a and a second node 14b. The first node 14a of each string light set 14 is electrically connected to the first electrode 12a, and the second node 14b of each string light set 14 is electrically connected to the second electrode 12b, so that the string light sets 14 forms circuit loops being parallel with each other.

Additionally, the number of the lamp holders 16 of each string light set 14 as shown in FIG. 1A is only 5, but the present invention is not limited thereto, and the number may be increased to N according to requirements of circuit design. In addition, each string light set 14 is further electrically connected to a resistor 19 respectively, so as to prevent entrance of an excessively large current value.

A circuit diagram of the plurality of string light sets and the movable decorative element of the decorative lighting device is described below. FIG. 1B is an equivalent circuit diagram of the decorative lighting device according to the present invention. Referring to FIG. 1B, the power source 12 in FIG. 1B is represented by a symbol V1. The plurality of string light sets 14 is represented by symbols S1, S2, S3, . . . , Sn, and can be expanded from including a first string light set S1 to including an N^{th} string light set Sn. The light-emitting elements 18 connected to each other in series of each string light set (that is, symbols S1, S2, S3, . . . , Sn) are represented by symbols LED1, LED2, LED3, . . . , LEDn. Further, the current regulating elements of the string light sets (that is, symbols S1, S2, S3, . . . , Sn) are represented by symbols R1, R2, R3, . . . , Rn.

For example, a voltage provided by a power supply Vin may vary according to the number of the light-emitting elements (LED1, LED2, LED3, . . . , LEDn). Normally, a start voltage required by a red LED is about V_{R}(V). If six red LEDs connected to each other in series are used, the required voltage is about (V_{R}(V)×6) totally. A start voltage required by a green LED or a blue LED is about V_{G}(V). If six green LEDs or six blue LEDs connected to each other in series are used, the required voltage is about (V_{G} (V)×6).

Breakover voltage values of the red, green, blue LEDs are different from each other. In addition, due to bias in manufacturing, even the breakover voltage values of the LEDs of the same color may be different. Generally, because when the number of the LEDs connected in series or in parallel is increased, the breakover voltage is averagely smaller than 3 V, during designing, the breakover voltage of the LED may be set as 3 V. However, the voltage value adopted during designing is not limited thereto.

A current Vin may vary according to the number of the LEDs. A current consumed by one LED is about I_{L} mA. If five LEDs connected in parallel are used, the required current thereof is (I_{L}×5) mA.

Since the transformer is directly used as the power supply, in order to protect the LED from being burnt by an excessively large current passing through the LED, the resistor is required to be used as the current regulating element, so as to make the current passing through the LED smaller than I_{L} mA. Generally, the current passing through the LED is smaller than 20 mA. However, a minimum current value adopted during designing is not limited thereto.

In view of the above, assuming that the number of the LEDs in each string light set is Y, and the total number of the string light sets is N, the required voltage V_{D} and the current I_{D} of the power supply Vin respectively are as follows.

VD=3(V)×Y

ID=20(mA)×N

Taking all factors into consideration, in order to prevent the LED being burnt, Vin uses a 12 V/200 mA power supply. Because when a power supply of a fixed voltage and a fixed current is directly used to supply power, no extra LED drive Integrated Circuit (IC) is required, thereby saving overall cost and being helpful for the increase of the number of the LED string lights in the future. In this design, the transformer with an output being 12 V/1.5 A is directly used to supply power. It should be specially noted that, if specifications of the LEDs to be used change, the voltage adopted by Vin also changes.

The decorative lighting device is applicable to be disposed on a decorative element. The decorative element may be a seasonal single string, which, for example, may be, but not limited to, a Christmas tree. The string light sets are connected to each other in parallel, such that when the number of the string light sets is increased, the voltage of the DC power supply is not required to be increased. Therefore, the number of the string light sets can be increased without being limited by the voltage.

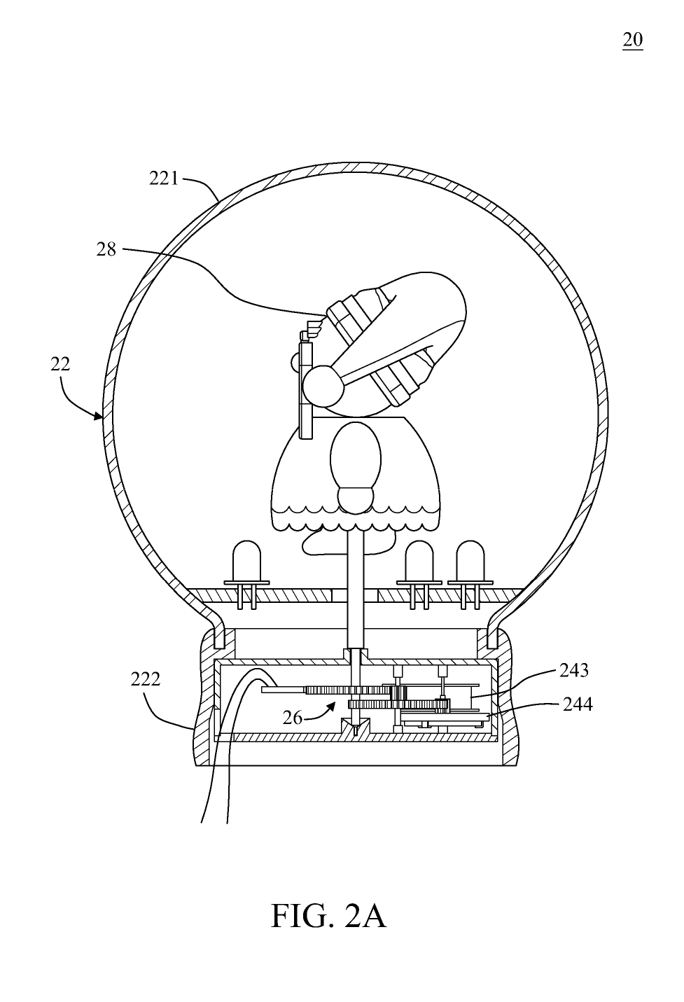

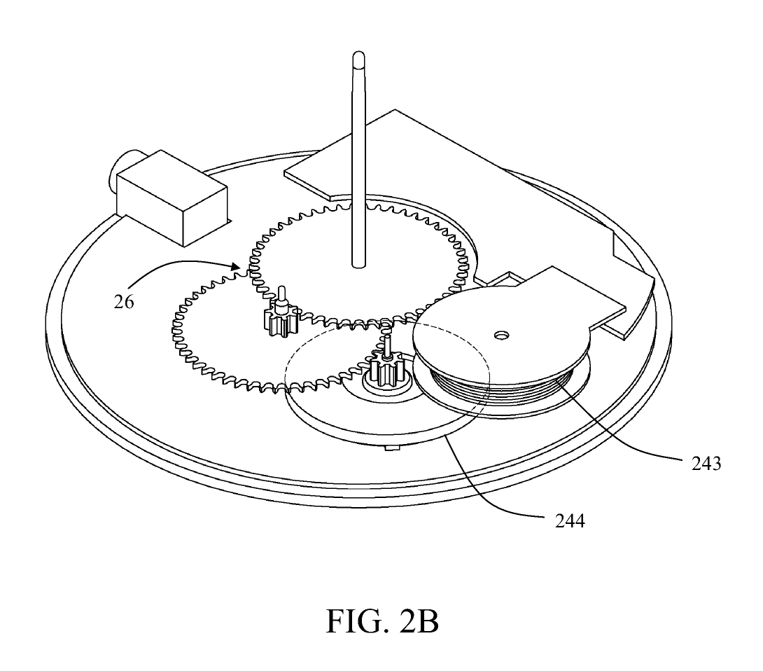

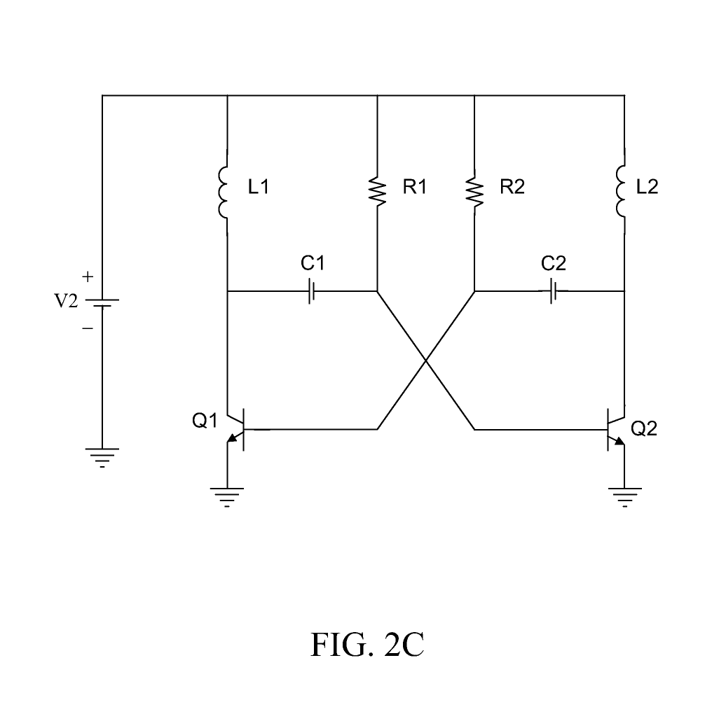

FIG. 2A and FIG. 2B are schematic views of a movable decorative element according to the present invention. The movable decorative element 20 includes a exhibition unit 22, a power unit 24, a transmission unit 26, and a decorative unit 28. The exhibition unit 22 has a case 221 and a base 222. The case 221 accommodates the decorative unit 28, and covers the base 222. The base 222 accommodates the power unit 24. The power unit 24 has a circuit board 241, a coil 242, and a magnet 244. The circuit board 241 is electrically connected to a wire of the lamp holders 16, and the circuit board 241 has a drive circuit (not shown). An electric power is provided for the coil 242 through the drive circuit. The transmission unit 26 has a plurality of gears 262 engaged to each other. One gear 262 is engaged to the magnet 244, and the other gear 262 is connected to the decorative unit 28 through a shaft lever in a pivoted manner. After being powered, the coil 242 forms an induced magnetic field alternately, and drives the magnet to rotate. Thus, the magnet drives the gears 262 engaged to each other to rotate simultaneously, so as to make the decorative unit 28 rotate in the case.

Referring to FIG. 2C, the drive circuit 25 includes a decorative element power supply V2, a first transistor Q1, a second transistor Q2, a first resistor R1, a second resistor R2, a first capacitor C1, a second capacitor C2, a first inductor L1, and a second inductor L2.

Two ends of the decorative element power supply V2 may be connected to the lamp holder. That is to say, the decorative element power supply V2 is the power supply provided by the current loop of the string light sets (S1, S2, S3, . . . , Sn).

The first inductor L1 and the second inductor L2 may be disposed on the coil 242 in different directions. Specifically, the first inductor L1 is wound around the coil 242 in a clockwise manner, and the second inductor L2 is wound around the coil 242 in a counterclockwise manner.

The first transistor Q1 has an input end, an output end, and a control end. The second transistor Q2 also has an input end, an output end, and a control end. One end of the first resistor R1 is connected to the decorative element power supply V2, and the other end of the first resistor R1 is connected to the control end of the second transistor Q2. One end of the second resistor R2 is connected to the decorative element power supply V2, and the other end of the second resistor R2 is connected to the control end of the first transistor Q1. One end of the first inductor L1 is connected to the decorative element power supply V2, and the other end of the first inductor L1 is connected to the input end of the first transistor Q1. One end of the second inductor L2 is connected to the decorative element power supply V2, and the other end of the second inductor L2 is connected to the input end of the second transistor Q2. One end of the first capacitor C1 is connected to the input end of the first transistor Q1, and the other end of the first capacitor C1 is connected to the control end of the second transistor Q2. One end of the second capacitor C2 is connected to the input end of the second transistor Q2, and the other end of the second capacitor C2 is connected to the control end of the first transistor Q1.

A breakover voltage of the first transistor Q1 is smaller than a breakover voltage of the second transistor Q2. Therefore, after the decorative element power supply V2 is input, the first transistor Q1 is conducted before the second transistor Q2.

The first capacitor C1 is charged through the first inductor L1 and the first resistor R1, and at the same time the second capacitor C2 is charged through the second inductor L2 and the second resistor R2. When the first transistor Q1 is conducted, the first capacitor C1 provides a reverse bias voltage for the second transistor Q2 through the first transistor Q1, so as to cut off the second transistor Q2. Meanwhile, the first capacitor C1 is discharged through the first transistor Q1, the input decorative element power supply V2, and the first resistor R1. Meanwhile, the second capacitor C2 is charged through the first transistor Q1 and the second inductor L2.

After the first capacitor C1 is discharged for a cycle T1, the reverse bias voltage provided by the first capacitor C1 for the second transistor Q2 disappears, so that the second transistor Q2 is conducted by a forward bias voltage provided by the first resistor R1, in which T1=0.7×a resistance value of the first resistor R1×a capacitance value of the first capacitor C1.

The second transistor Q2 is conducted, and the second capacitor C2 provides the reverse bias voltage for the first transistor Q1 through the second transistor Q2, so that the first transistor Q1 is cut off. Meanwhile, the second capacitor C2 is discharged through the second transistor Q2, the decorative element power supply V2, and the second resistor R2. Meanwhile, the first capacitor C1 is charged through the first transistor Q1 and the first inductor L1.

After the second capacitor C2 is discharged for a cycle T2, the reverse bias voltage provided by the second capacitor C2 for the first transistor Q1 disappears, so that the first transistor Q1 is conducted by a forward bias voltage provided by the second resistor R2, in which T2=0.7×a resistance value of the second resistor R2×a capacitance value of the second capacitor C2.

By repeating the above operation manner, the first transistor Q1 and the second transistor Q2 are conducted and cut off in turn, so as to make the first inductor L1 and the second inductor L2 generate the magnetic field alternately.

Referring to FIG. 2A, FIG. 2B, and FIG. 2C, only a very small current is required to drive the movable decorative element 20. Therefore, the light-emitting elements in each current loop may be selectively replaced with the movable decorative elements 20.

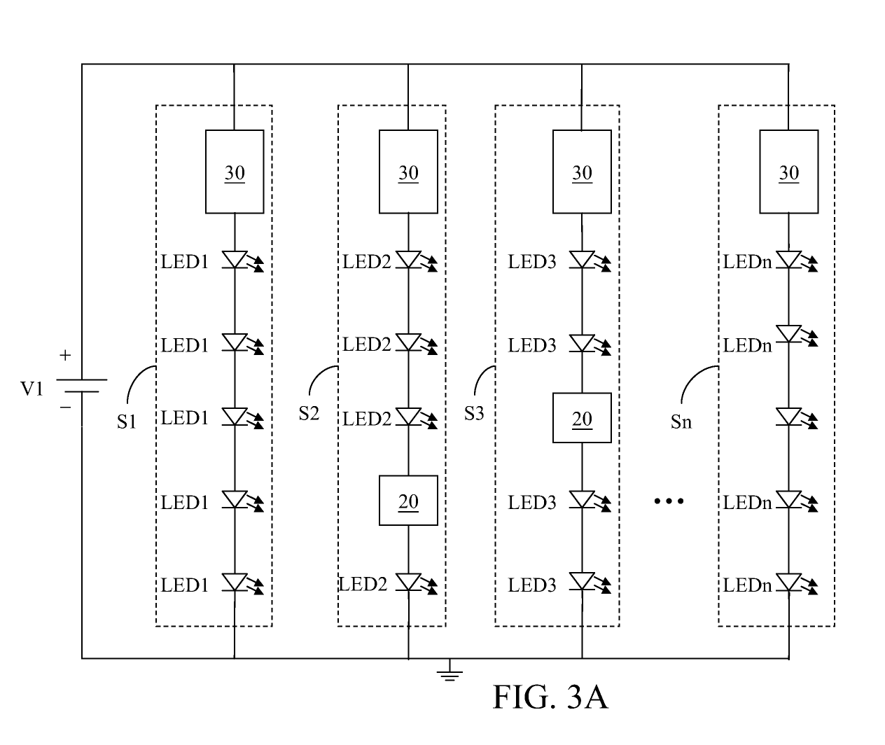

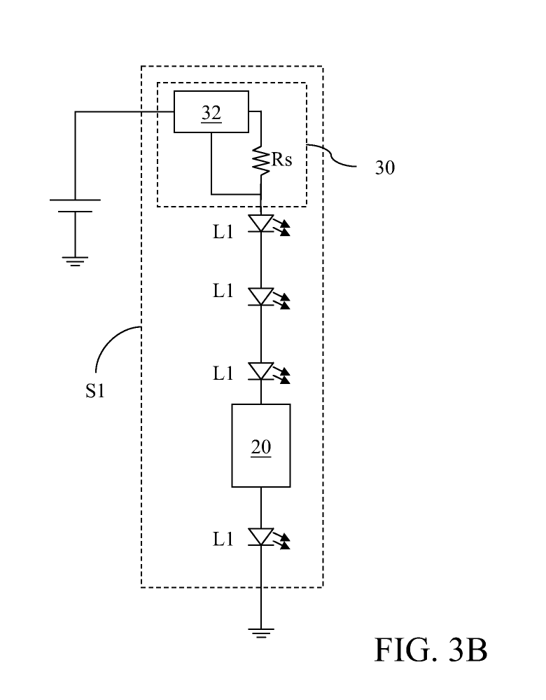

FIG. 3A and FIG. 3B are schematic views of connection of a current regulating element according to the present invention. In this embodiment, the current regulating element is an automatic voltage regulating constant current device 30.

The automatic voltage regulating constant current device 30 is used to output a constant current. The constant current can drive LEDs of various colors. The light emitting elements (LED1, LED2, LED3, . . . , LEDn) of the string light set respectively are LEDs of different colors. Therefore, the decorative lighting device of the present invention has abundant changes.

The automatic voltage regulating constant current device 30 may be an Integrated Circuit (IC) 32 of type LM317. The IC 32 has an input pin, an output pin, and an adjustment pin. The input pin is connected to the power supply V1, and the output pin is connected to the string light sets 14. A control resistor Rs is connected between the adjustment pin and the output pin.

The automatic voltage regulating constant current device 30 can output a constant current, and the value of the constant current is controlled by a resistance value of the control resistor Rs.

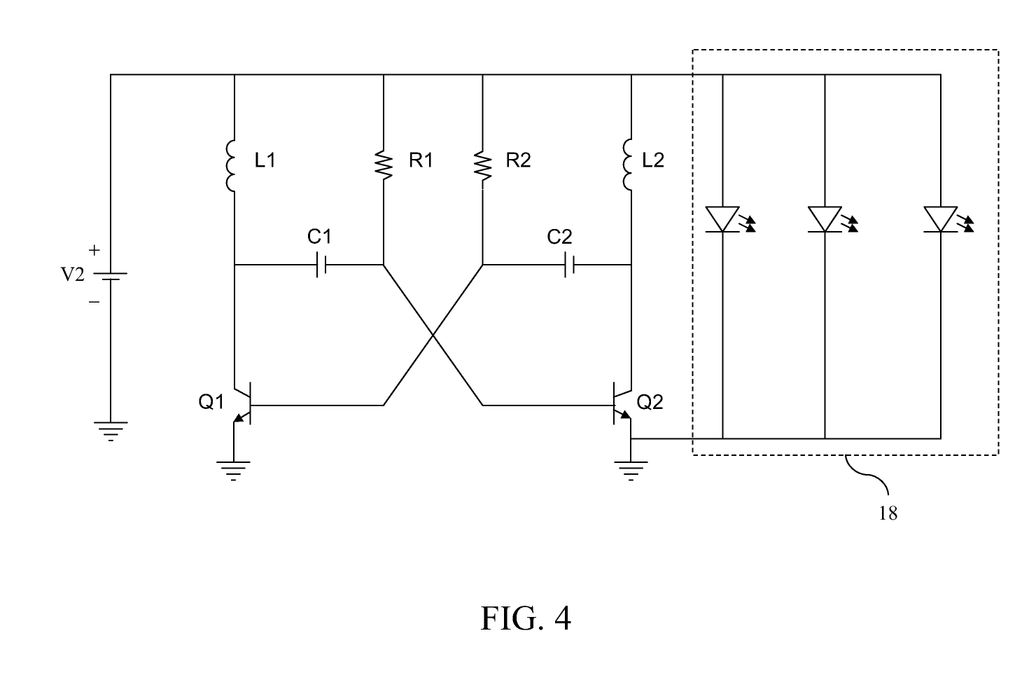

In an embodiment of the present invention, in order to make the movable decorative element 20 diversified, multiple light-emitting elements 18 may be added into the movable decorative element 20. Referring to FIG. 4, besides the drive circuit 25, the decorative element power supply V2 input into the movable decorative element 20 may also supply a power to the light-emitting elements 18 disposed in the movable decorative element 20. In FIG. 4, the light-emitting element 18 is an LED. An anode of each LED is connected to the decorative element power supply V2, and a cathode of each LED is connected to the ground. Thus, the movable decorative element 20 can not only rotate but also emit light rays of different colors.

The movable decorative element 20 shown in FIG. 4 that has the light-emitting elements 18 is applicable to a circuit in FIG. 1B or FIG. 3A. That is to say, no matter whether the decorative lighting device has the automatic voltage regulating constant current device 30, the decorative lighting device can be installed with the movable decorative element 20 having the light-emitting elements 18.

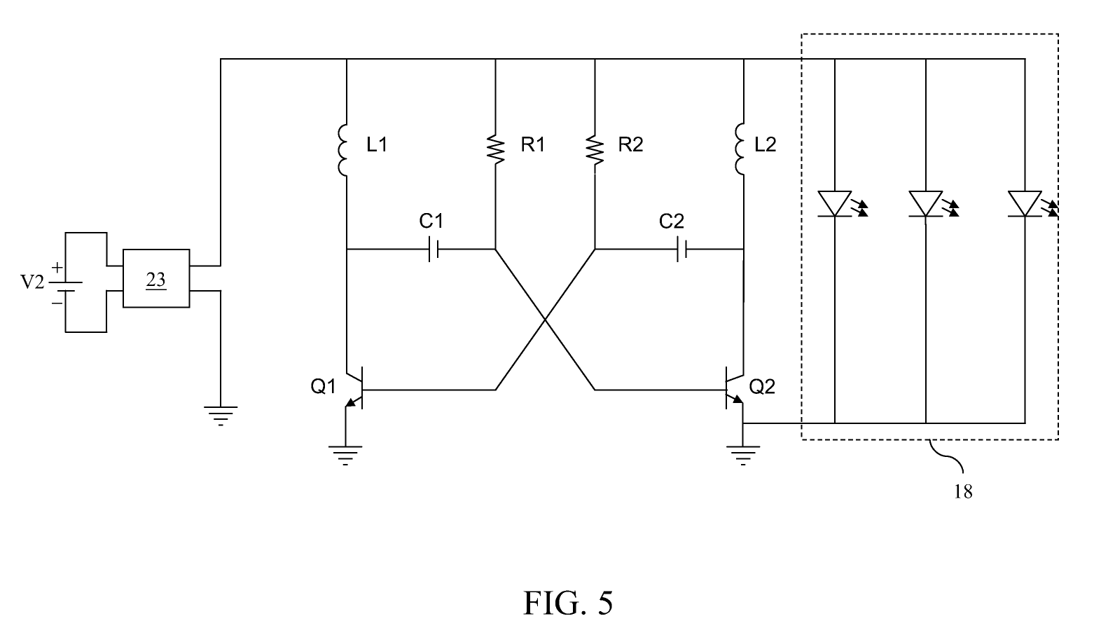

Referring to FIG. 5, in an embodiment of the present invention, in order to enable the input voltage to be steadily supplied to the movable decorative element 20 having the light-emitting elements 18, the movable decorative element 20 may have a DC/DC converter 23. The DC/DC converter 23 receives a decorative element power supply, and outputs a power of a steady voltage after conversion. The DC/DC converter 23 has a wide input voltage range, in which when the voltage is not sufficient, the DC/DC converter 23 can be automatically switched to step up the voltage, and when the voltage is excessively high, the DC/DC converter 23 can be automatically switched to step down the voltage. The DC/DC converter 23 outputs the power of the steady voltage to the first resistor R1, the second resistor R2, the first inductor L1, the second inductor L2, and the light-emitting elements 18.

Accordingly, the movable decorative element 20 shown in FIG. 5 that has the DC/DC converter 23 is applicable to the circuit in FIG. 1B or FIG. 3A. That is to say, no matter whether the decorative lighting device has the automatic voltage regulating constant current device 30, the decorative lighting device can be installed with the movable decorative element 20 having the DC/DC converter 23.

Through the decorative lighting device of the present invention, the movable decorative element and the light-emitting elements can be integrated into the same circuit. In addition, when the number of the movable decorative elements and the number of the light-emitting elements are required to be increased, power supply equipment is not required to be added, and the numbers can be increased freely.

What is claimed is:

1. A decorative lighting device, electrically connected to a power supply having a first electrode and a second electrode, the decorative lighting device comprising:
at least one movable decorative element; and
a plurality of string light sets, wherein each string light set respectively has a plurality of lamp holders connected to each other in series, and the lamp holder is respectively electrically connected to a light-emitting element,
wherein each string light set respectively has a first node and a second node, each first node is electrically connected to the first electrode, each second node is electrically connected to the second electrode, the power supply drives each string light set to form a current loop respectively, all of the light-emitting elements electrically connected to the lamp holders in each current loop are selectively replaced with the movable decorative elements, so that the lamp holders respectively supply a power for the light-emitting elements or the movable decorative elements.

2. The decorative lighting device according to claim 1, wherein the movable decorative element comprises:
a decorative unit;
a power unit, having a circuit board, a coil, and a magnet, wherein the circuit board is electrically connected to the lamp holder, the circuit board has a drive circuit, the drive circuit provides a power for the coil, and after being powered, the coil forms an induced magnetic field, and the coil drives the magnet to rotate;
a transmission unit, having a plurality of gears engaged to each other, wherein one gear is engaged to the magnet, and the other gear is pivoted to the decorative unit through a shaft lever; and
an exhibition unit, having a case and a base, wherein the case accommodates the decorative unit and covers the base, and the base accommodates the power unit.

3. The decorative lighting device according to claim 2, wherein the drive circuit comprises a decorative element power supply, a first transistor, a second transistor, a first resistor, a second resistor, a first capacitor, a second capacitor, a first inductor, and a second inductor, wherein the first transistor has an input end, an output end, and a control end, the second transistor has an input end, an output end, and a control end, one end of the first resistor is connected to the decorative element power supply, and the other end of the first resistor is connected to the control end of the second transistor, one end of the second resistor is connected to the decorative element power supply, and the other end of the second resistor is connected to the control end of the first transistor, one end of the first inductor is connected to the decorative element power supply, and the other end of the first inductor is connected to the input end of the first transistor, one end of the second inductor is connected to the decorative element power supply, and the other end of the second inductor is connected to the input end of the second transistor, one end of the first capacitor is connected to the input end of the first transistor, and the other end of the first capacitor is connected to the control end of the second transistor, and one end of the second capacitor is connected to the input end of the second transistor, and the other end of the second capacitor is connected to the control end of the first transistor.

4. The decorative lighting device according to claim 3, wherein the movable decorative element has at least one light-emitting element.

5. The decorative lighting device according to claim 4, wherein the plurality of string light sets further comprises an automatic voltage regulating constant current device, the light-emitting element of each string light set has a different breakover voltage, and the automatic voltage regulating constant current device outputs a constant current to each string light set.

6. The decorative lighting device according to claim 5, wherein the movable decorative element has a DC/DC converter, and the DC/DC converter has a wide input voltage range, and outputs a power of a steady voltage.

7. The decorative lighting device according to claim 1, wherein the plurality of string light sets further comprises an automatic voltage regulating constant current device, the light-emitting element of each string light set has a different breakover voltage, and the automatic voltage regulating constant current device outputs a constant voltage to each string light set.

8. The decorative lighting device according to claim 1, wherein the movable decorative element has a DC/DC converter, and the DC/DC converter has a wide input voltage range, and outputs a power of a steady voltage.
